(19) United States
(12) Patent Application Publication
(10) Pub. No.: US 2013/0145145 A1
(43) Pub. Date: Jun. 6, 2013

(54) SYSTEM AND METHOD OF SECURING DATA USING A SERVER-RESIDENT KEY

(71) Applicant: Bjorn Michael Dittmer-Roche, New York, NY (US)

(72) Inventor: Bjorn Michael Dittmer-Roche, New York, NY (US)

(21) Appl. No.: 13/628,254

(22) Filed: Sep. 27, 2012

Related U.S. Application Data
(60) Provisional application No. 61/539,967, filed on Dec. 5, 2011.

(51) Int. Cl. H04L 9/08

(52) U.S. Cl. 713/153

(57) ABSTRACT

A system and method for increasing security of data is presented. This system uses a remote server to increase the security of locally stored data, even in the presence of physical and software security threats. This method is significantly bolstered when at least a small portion of memory on the local machine used to temporarily store the encryption key is safe from physical and software attacks and can be further bolstered if user-interaction is required upon authentication.

### CROSS-REFERENCE TO RELATED APPLICATIONS

This application claims the benefit of U.S. Provisional Patent Application No. 61/539,967, filed on Sep. 27, 2011, and completed on Dec. 5, 2011 with the submission of a reply to the notice of incomplete application papers.

U.S. Pat. Nos. 4,200,770, 4,218,582, 4,405,829, 4,424,414, and 4,995,082, and U.S. Patent Application Publication No. 20070297610 are each hereby incorporated herein by reference, in their entirety. The embodiments, features, systems, devices, materials, methods and techniques described herein may, in certain embodiments, be applied to or used in connection with any one or more of the embodiments, features, systems, devices, materials, methods and techniques disclosed in the above-mentioned patents and patent application.

### BACKGROUND

When desktop computers, servers and other devices contain important information, the data must be secured to prevent unwanted access. However, in many cases, especially when physical security is limited, such as with mobile devices, there are few options for providing for security. Instead, most solutions for security of data at rest assume large degree of physical security.

One possible solution for Internet-connected devices, is to offer a “remote wipe” function, which allows the user, should they notice their device is lost or stolen, to delete all the data on the device from another Internet-enabled device, such as a desktop computer. This system assumes that the user is able to delete the data on the device before it can be exploited by the party that has stolen or found the missing device, and while it is still connected to the Internet. It offers no security against malware.

Another method is to store all data on a secure, remote server and develop a system, such as a secure web interface, which allows the end user to view and manipulate the data securely without storing any of the data locally. This system works well if the end user always has a network connection to the server when they need it and if the data can be worked on in small enough pieces that do not need to be cached or otherwise stored on the client machine where it would be vulnerable to software or physical security attack. Many systems, such as customer facing online banking systems, work this way.

Another solution is to encrypt the local data. This solution is offered my many of today's mainstream operating systems, and involves encrypting some portion of the computer's storage, such as a disk, a disk partition, or a folder, such as the user's “home directory” using a key derived from a password. Once the password is entered, the home directory or other data is unencrypted as needed by the OS. See, e.g., Chapter 17 of Applied Cryptography, Second Edition, Protocols, Algorithms, and Source Code in C. Bruce Schneider, 1996. John Wiley and Sons, Inc. New York. This is effective in many ways: assuming the password is strong, it is difficult for an adversary to access the data in encrypted storage area. However, malware running on the machine could read the data off the home directory as easily as other applications: it simply has to wait for the user to enter her password and the OS will decrypt the required data on demand. Moreover, if an adversary has physical access to the computer, they may be able to determine the password or key using information stored on the computer, via a dictionary or related attack. Once the password or key is determined, the computer's data is no longer secure.

### SUMMARY

This application offers a new way to secure data that overcomes many of these limitations. We will see that it can also be used in collaborative environments—allowing users to share data with one another temporarily, even if the data is large enough that it needs to be cached locally.

It is assumed, throughout this disclosure, that the reader is familiar with the basic concepts of computers, including data storage, and software and process management; cryptography, including keys, hashes, stream and block ciphers, nonces, and so on; and networking, including the internet, and file and data transfer techniques, including secure transfer protocols such as SSL/TLS and HTTPS.

### BRIEF DESCRIPTION OF THE DRAWINGS

FIG. 1 shows a computer system 100 configured for editing documents, according to an illustrative embodiment of the invention;

FIG. 2 shows out of order or “on demand” decryption of records within a file, according to an illustrative embodiment of the invention;

FIG. 3 shows an illustrative embodiment of the invention, including server and client with encrypted data and encryption keys ultimately residing on both computers;

FIG. 4 shows the method used to transfer data and encryption keys from server to client, according to an illustrative embodiment of the invention;

FIG. 5 shows an illustrative embodiment of the invention in which decryption is provided as a service to client software, possibly as a library or as a service provided by the operating system; and

FIG. 6 shows how encryption and decryption can be decoupled using asymmetric keys, according to an illustrative embodiment of the invention;

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, etc. In other instances, well-known structures and methods associated with computers, computer software, networking, and computing devices have not been shown or described in detail to avoid unnecessarily obscuring descriptions of the embodiments.

Unless the context requires otherwise, throughout the specification and claims which follow, the word “comprise” and variations thereof, such as “comprises” and “comprising,” are to be construed in an open, inclusive sense, that is, as “including, but not limited to.” Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The section headings provided herein are for convenience only and do not interpret the scope or meaning of the embodiments of the present disclosure.

### Description of an Example Computer System

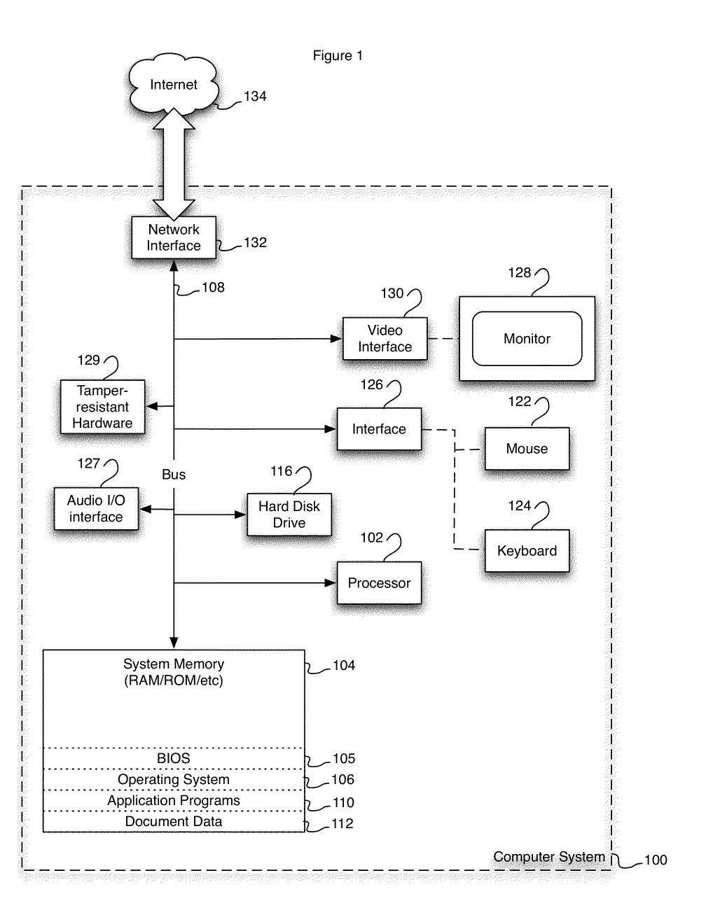

FIG. 1 and the following discussion provide a brief, general description of a computer system 100 configured for editing documents, such as word processing documents, spreadsheet documents, business, financial or legal oriented software, digital audio/video software or any other type of software that may require or benefit from enhanced security features. Although not required, the embodiments will be described in the general context of computer-executable instructions, such as program application modules, objects, or macros being executed by a computer. These instructions may be described as software, when they may be implemented as software, firmware, macros, directly in hardware, or in any other manner in which can be executed. Those skilled in the relevant art will appreciate that the illustrated embodiments as well as other embodiments can be practiced with other computer system configurations, including digital audio and/or video editing hardware, handheld devices, multiprocessor systems, microprocessor-based or programmable consumer electronics, personal computers (“PCs”), network PCs, embedded systems, “set top boxes,” automated teller machines (“ATMs”) and the like. The embodiments can be practiced in distributed computing environments where tasks or modules are performed by remote processing devices, which are linked through a communications network. In a distributed computing environment, program modules may be located in both local and remote memory storage devices.

FIG. 1 shows a computer system 100, which comprises a computer. The computer system 100 and this method for securing data will be described in greater detail below. The computer system 100 may take the form of a conventional PC, which includes the processor 102, the system memory 104 and a system bus 108 that couples various system components including the system memory 104 to the processing unit 102. The computer system 100 will at times be referred to in the singular herein, but this is not intended to limit the embodiments to a single computing device, since in certain embodiments, there will be more than one networked computing device involved. The processor 102 may be any logic processing unit, such as one or more central processing units (CPUs), digital signal processors (DSPs), application-specific integrated circuits (ASICs), field programmable gate arrays (FPGAs), Graphics Processing Units (GPUs) etc. Unless described otherwise, the construction and operation of the various blocks shown in FIG. 1 are of conventional design. As a result, such blocks need not be described in further detail herein, as they will be understood by those skilled in the relevant art. The system bus 108 can employ any known bus structures or architectures, including a memory bus with memory controller, a peripheral bus, and a local bus. The system memory 104 may include read-only memory (“ROM”) and random access memory (“RAM”). A basic input/output system (“BIOS”) 105, which can form part of the ROM, contains basic routines that may help transfer information between elements within the computer system 100 (e.g., during start-up).

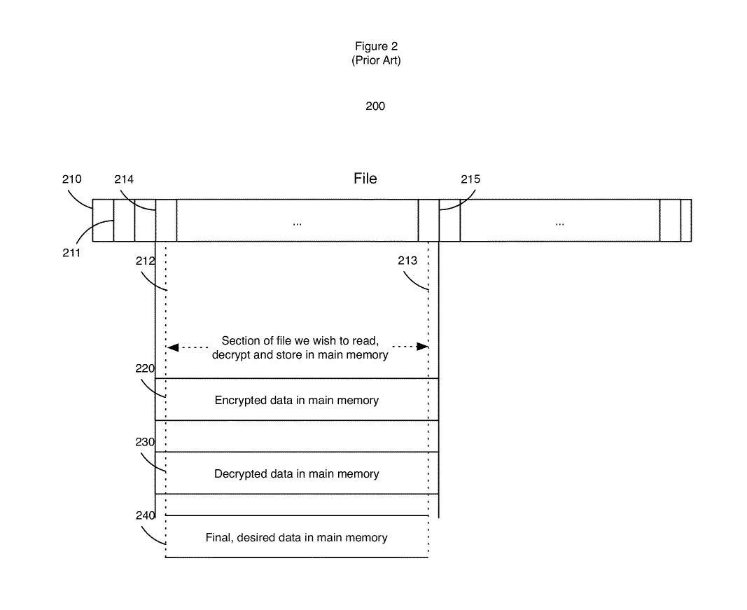

The computer system 100 may also includes a hard disk drive 116 for reading from and writing to a hard disk. Though not shown, the computer system 100 may further or alternatively include other storage devices, such as an optical disk drive and/or a flash-based storage device. The hard disk drive 116 communicates with the processor 102 via the system bus 108. The hard disk drive 116 may include interfaces or controllers (not shown) coupled between the hard disk drive 116 and the system bus 108. The hard disk drive 116, and its associated computer-readable media may provide nonvolatile storage of computer-readable instructions, document data files 112, program modules and other data for the computer system 100. In one embodiment, the computer has a special, tamper-resistant hardware module 129 that may store or retrieve small amounts of information, or process data. A variety of program modules can be stored in the system memory 104, including an operating system 106, one or more application programs 110. In such an embodiment, this application program 110 may provide much of the functionality described below with reference to FIGS. 2 through 5. While shown in FIG. 1 as being stored in the system memory 104, the operating system 106, application programs 110, and document file 112 may be stored in a nonvolatile storage device, such as the hard disk drive 116, or on the network (not shown) or even in the hardware itself. One skilled in the relevant art will appreciate that this is just one possible organization of data in a computer system. A user can enter commands and information into the computer system 100 using a mouse 122 and/or a keyboard 124. Other input devices can include a microphone, other musical instruments, scanner, camera, etc. In one embodiment, one or more of these input devices may be used in order provide authentication data. These and other input devices are connected to the processor 102 through an interface 126 such as a universal serial bus (“USB”) interface that couples to the system bus 108, although other interfaces such as another serial port, a game port or a wireless interface may also be used. The computer system 100 may further include an audio I/O interface 127, such as a sound card. The audio I/O 127 may enable a user to import audio from an external source, and/or play audio on one or more speakers. A monitor 128 or other display device may be coupled to the system bus 108 via a video interface 130, such as a video adapter.

Although not shown, the computer system 100 can include other output devices, such as printers. In one embodiment, the computer system 100 operates in a networked environment using one or more logical connections to communicate with one or more remote computers or other computing devices. These logical connections may facilitate any known method of permitting computers to communicate, such as through one or more LANs and/or WANs, such as the Internet 134. In one embodiment, a network interface 132 (communicatively linked to the system bus 108) may be used for establishing communications over the logical connection to the Internet 134. In a networked environment, program modules, application programs, or documents, or portions thereof, can be stored outside of the computer system 100 (not shown). Those skilled in the relevant art will recognize that the network connections shown in FIG. 1 are only some examples of ways of establishing communications between computers, and other connections may be used.

### On-Demand File Decryption

This disclosure refers to decrypting and encrypting files “on the fly” or “on demand.” This means that when the data is required it can be retrieved as needed, without having to perform a significant amount of work not related to reading the requested data. In addition, these terms imply that it is not necessary to wait for unrelated processes or data that may be located on other systems or devices. It is often desirable to have a system that allows part of a file to be decrypted or encrypted without having to decrypt or encrypt the entire file. For example, imagine an encrypted file containing many records residing on a hard disk drive, which is too large to fit into RAM. It may be desirable to read every record, one at a time, in order to process them, or to read only some of the records in the file into RAM and process them. For these records to be readable “on the fly”, reading a record at the end of the file must not depend on reading and processing the entire contents of the file, most of which is data we are not presently interested in.

This process is the subject of prior art; however, we will demonstrate, briefly, how it may be done. If the entire file is to be read sequentially, the problem is simply a matter of decrypting the file sequentially and feeding the results to the application which whishes to process it. The key and nonce, if required, must be present for decryption to occur. If the file data needs to be accessed out of order, however, special considerations must be made.

FIG. 2 shows how we can decrypt a file out of sequence. Most ciphers operate on data in fixed-size blocks, called words, and so an encrypted file 210 may be seen as a plurality of sequential data words 211. Some Ciphers, such as block ciphers in ECB mode, allow conversion of any ciphertext word to any plaintext word regardless of where in the file it is found. Other ciphers can perform this same function, but only if they know where in the file the word was originally located. Other ciphers require that all prior words be decrypted/encrypted in order to decrypt/encrypt a given word. This final type of cipher may offer advantages such as speed or security but does not allow records inside the file to be read on demand, and therefore may not be ideal for use in this situation if random access within individual files is required.

The size and other properties of the words are determined by the cypher and protocol used to encrypt the file, however, words are usually equally sized chunks which immediately follow one another, except for the last word which may be incomplete and therefore of a smaller size. Other configurations are possible, for example, information about the cipher may be stored before the first word, or between or after words. Checksum data may also be included, most likely between or after the word data.

When part of the file must be read and converted to plaintext, for example between two positions (212 and 213) into working memory (usually RAM) 240, we must read not only the corresponding data in the file, but also possibly some additional data to ensure that words are read in their entirety (214 to 215). Once the data is read, into RAM 220, it can be decrypted 230, and the unneeded data can be disposed, leaving only the desired data 240. In general, if N bytes are requested, and M is the word-size, it is not necessary to read more than N+2*M bytes.

Encryption follows a similar process. In this case, if part of a file is to be overwritten and that data does not align with word boundaries, some of the existing file data may need to be read and decrypted and then combined with the new data in order to ensure that complete words are correctly written.

### Client-Server Model

Although this disclosure refers to the traditional client-server paradigm, nothing requires that it be implemented as such. For example, one embodiment may be implemented where the “server” is actually a piece of specialized, tamper-resistant hardware running inside a standard desktop computer. Other parts of this computer would then constitute the “client.” The cipher key may be stored in a safe location separate from the data, such as a separate server computer or other safe location.

### TERMINOLOGY

This disclosure distinguishes between two types of memory on the client computer. We call these types “General Memory” and “Protected Memory,” which are not terms that are in general use in the industry. However, modern computers and related devices generally do have different kinds of memory, and many systems even separate the same kind of memory into different sections. These differences have security implications that may be exploited by an attacker. For example, many desktop computers have non-volatile storage, such as hard disk drives, and volatile storage such as RAM. Storage on a non-volatile medium creates a physical security issue: if an attacker gains physical access to the computer, such as through theft, data on non-volatile storage is considerably more likely to be readable than data in volatile RAM, which is generally erased or unreadable after the computer is turned off. In addition, the client may be operating on a machine that is susceptible to viruses and other malware, which also have access to the non-volatile memory.

Moreover, many modern computer systems prevent different applications running concurrently from accessing the same address space in RAM. This feature, often called “memory protection” and often implemented by a combination of the OS the CPU and the MMU (memory management unit), is designed to keep applications from interfering with each other, even if they are run by users with the same or similar permissions. Often, malware such as viruses and Trojans can attain the same permissions as the user, and having separate memory space unique to an application represents a more secure location for sensitive information than shared RAM.

Seeing these distinctions, we use the term “Protected Memory” for any memory which is at least as secure for the desired purpose than “General Memory,” even if general memory is, in and of itself, somewhat secure, and protected memory is not completely secure from potential adversaries. We also note that protected memory may or may not be “protected” by the feature known as “memory protection.”

Finally, we note that the terms “secret information,” and “sensitive information” may be used, even if the information is not known to be secret or sensitive. It is enough to know that it might be, or that the system might be used in such a way that the information it is processing is sensitive, or that part of it is or might be sensitive. It may even happen that the user or users of the system do not want others to know that certain information exists or is in their possession. In any case, the user may desire some amount of protection against individuals, software or agents, who we refer to as “adversaries,” “attackers” or “the enemy.” Thus, release of information to an adversary is potentially damaging, even if the information is not secret or sensitive per se. We continue to use the terms sensitive and secret in these cases; however, we may simply refer to “information” or “data” when the context makes it clear that the information is to be kept away from the enemy.

### System Design

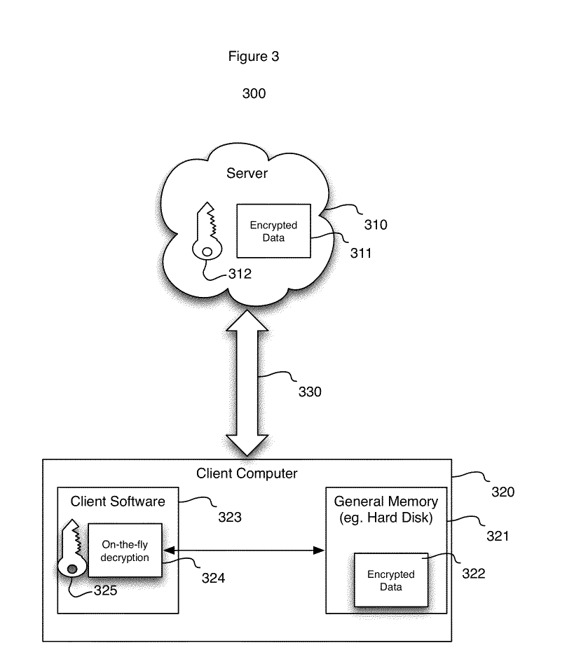

In one embodiment (FIG. 3), the system 300 includes data storage on both the server 310 and client 320. In this embodiment, all sensitive data can be lost from the client without any damage to the overall system because the client data is simply a copy of the server data. The client data can be thought of as a cache. In this case, the client may use the network connection, 330, to retrieve all the encrypted data 311 on the server, or only some subset that it needs immediately or expects to need. The encrypted data may be stored locally 322 in the client computer's general memory 321.

The server stores the cipher key 312 associated with the encrypted data. The client computer 320 may retrieve the key from the network and store it in protected memory. In the embodiment shown in FIG. 3, the key is stored inside the client software's memory space 323.

Once the sensitive data is stored locally, 322, the client software 323 may access the data by decrypting portions of it “on-the-fly” 324, within the client software using the locally stored key 325. Note that, in this embodiment, unencrypted data is never exposed outside the client software, making it highly secure against physical and software adversaries. In addition, if the communication channel 330 is secure, it is difficult for the enemy to gain access to the cipher key.

On-the-fly decryption in this system may be performed in a manner similar to on-the-fly decryption as described in the prior art, such as systems which perform on-the-fly decryption and encryption of data on non-volatile storage: using the key 325 and encrypted data 322, the data, or required portion thereof, can be decrypted into the client software's memory space and processed.

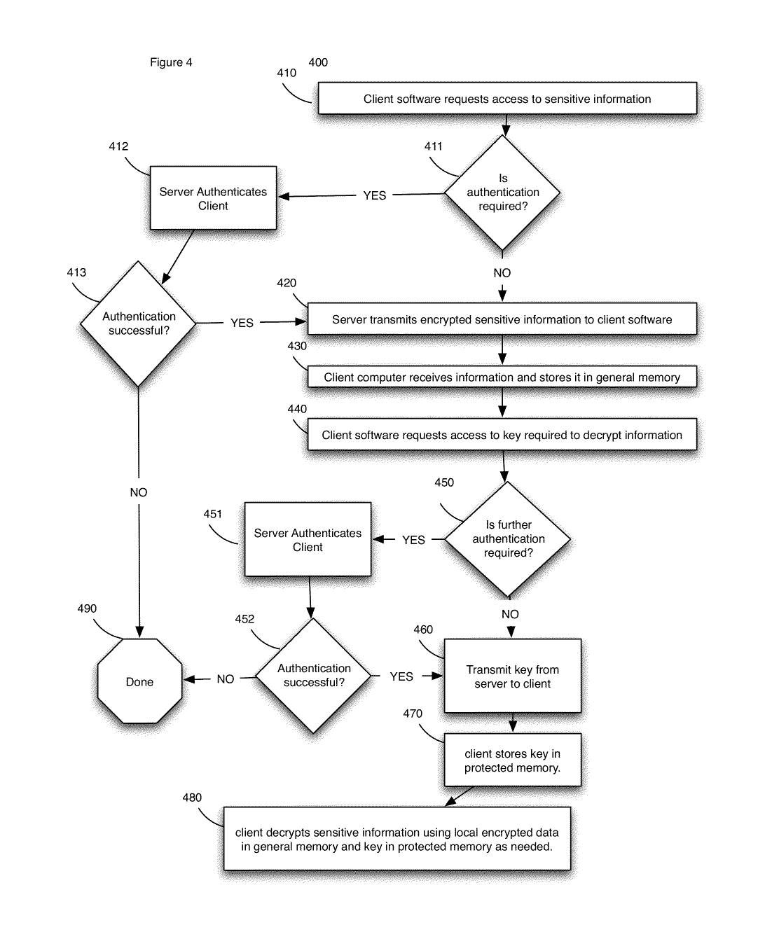

We have just described the system design and suggested why it might be secure against a wide variety of attacks. We will now describe the step-by-step process, illustrated in FIG. 4, that the client software would use to access the sensitive data. First, the client software requests access to sensitive information, 410. If the server requires authentication to access the information 411, and such authentication has not already been performed, the server authenticates the client 412. If authentication is unsuccessful, the process is complete 490. The client may reinitiate the process if desired. Upon successful authentication or when no authentication is required, the server transmits the encrypted, sensitive data to the client, 420, which then, 430, stores the information, still encrypted, in general memory.

Once the information is stored locally, the client software requests the key from the server 440. If the server requires further authentication, 450, the authentication is performed 451. If the authentication fails 490, the process is complete. The client may retry, if the system allows it. If authentication is successful, the key is transmitted from the server to the client computer 460 and stored by the client software in protected memory 470.

Now the client software has access to both the key and the encrypted data, and it can decrypt the information as needed 480.

In one embodiment, a different server may be used for the key and the data. In other embodiments, the sensitive data may already be copied onto the client computer, or it may exist on the client computer and not the server. In these embodiments, steps 420 and 430 are not required. In such embodiments, the local data would not be a cache of data that is stored on the server, but would be the primary copy of data. The server may be used for backup, or play no role in data storage roll at all, only key storage. Furthermore, as noted, some systems may have different authentication requirements. This fact may allow some of the authentication steps to be omitted. That is, the checks for authentication, 411 and 450, may not need to be run every time or in every embodiment.

When creating or modifying data, the client software must encrypt or re-encrypt the data and possibly upload the data to the server where it may be replaced or added to the data there. The process of modifying and creating data is otherwise similar enough to reading and creating data that anyone sufficiently familiar with the necessary art can see how this is done.

Many ciphers require nonce information in addition to keys. For most ciphers, this information need not be secret, and so it may be transmitted, unencrypted, from server to client with the encrypted sensitive information, and/or may be stored alongside the encrypted sensitive information as a set. Nonces may also be transmitted alongside the key if that is appropriate, or a separate transfer may be made for each required nonce.

For transfers that transmit key or password information, it may be necessary to use an encrypted protocol such as SSL/TLS to prevent eavesdropping. While not strictly necessary, it may be advisable to us an encrypted protocol during all transfers, even for information that is already encrypted. This ensures that protocol information, such as headers and so on are encrypted along with the data. In addition, the extra layer of encryption may provide additional security when the data is in transit and potentially more vulnerable to the enemy.

### System Design—Cipher and Key Storage

In some embodiments, the key cannot be cached locally in shared memory space without risking access from malicious software or malicious users. Because the security of most ciphers is dependent entirely on the secrecy of the key, we must store the key where it is safe from malicious users. On the server, the key is generally assumed to be safe. Servers can be “hardened” against malicious attacks, and, in particular, can be made physically secure. The client computer, however, may be more vulnerable to loss, theft, and software attack. On these systems, we must use caution, storing the key only in protected memory space. Doing so is particularly effective on modern computers and operating systems that offer OS and hardware-level memory protection, volatile memory and other security features. Standard precautions with highly sensitive material must be taken with the key; for example, the key in the memory space should be overwritten, or “wiped” when it is no longer in use, possibly multiple times depending on the hardware used and the presumed risk. In particular, most systems will not want the value of the key to outlive the client application. Because keys are generally small compared to the data, this can be managed much more easily than attempting to maintain the same level of security with the raw, unencrypted data.

### Authentication

Authentication may occur using any existing authentication method, including, for example username/password. Authentication may or may not be required for retrieving data from or submitting data to the server, but it generally is required when retrieving the key from the server. This allows only authorized users to read or write the encrypted data. Exceptions are possible. For example, the server may store the data unencrypted, and use encryption and encryption keys for only temporary file transfer, caching and so on. In this case, keys can be more freely distributed because the data will be reencrypted every time it is accessed from a client.

Besides, username/password, other authentication techniques are possible, including, but not limited to other challenge-response methods, Turing tests, such as CAPTCHAs, LDAP, X.509, IP-based authentication, biometric, Kerberos, and even multifactor authentication. Whatever authentication is used to access the key, it must be understood that access to the key allows the end user to decrypt the data as well. Therefore, it may be desirable to require some level of user interaction before the server can retrieve the key.

Some authentication systems allow the user to store authentication information (such as an authentication key or cookie) and reuse it. This may be a significant convenience; however, if the information is extremely sensitive, having a cookie stored on the system may be equivalent to having the decryption key stored on the system. This is why, in one embodiment, the server may require authentication to access its basic services, but require a second level of authentication to access the key. In order to maintain some of the simplicity of stored authentication information, the second level of authentication may be simpler. For example, a short number or single word may be used. The information required to access the key, if stored in the client application, must be protected with the same level of caution as the key. In many embodiments, it may not be necessary to store the information for the second level of authentication at all, which reduces the security threat involved.

### Externalized Functionality

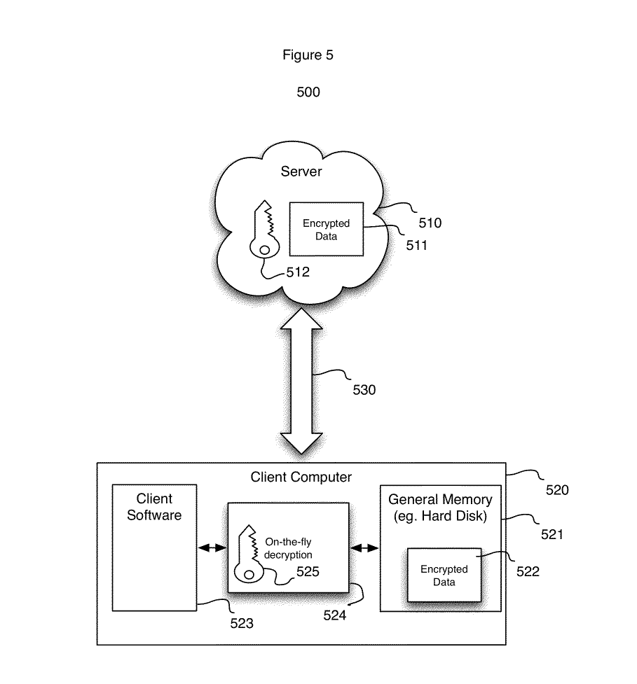

The decryption functionality in this disclosure has thus far been described as being implemented inside the client software. However, it is also possible to implement it externally, as shown in FIG. 5. In this embodiment, the decryption functionality requires access to the cipher key from the client software or the server directly. In some cases, this embodiment is not secure; however, in others it may be just as secure as the embodiment previously discussed. For example, it may be possible to provide a library that can be accessed by third party client software, either via static or dynamic linking. It may even be possible to provide this functionality as a service of the operating system or some hardware on the computer. In this case, it may be desirable to only allow trusted client software access to this service. Conceivably, this client software could be tested to see if it is a known software entity and to see if it has been tampered with before access is granted.

Encryption vs. Decryption

We note that many of the sections of this disclosure discuss encryption of data but not the corresponding decryption, or vice versa. As would be obvious to one skilled in the relevant art, the encryption and decryption responses can be easily reversed.

It is possible to implement this invention such that the client has access only to the key or keys needed to encrypt or decrypt, but not both, possibly depending on the client's assigned permissions. We will describe how this can be done below.

It is also possible to implement limited encryption/decryption features in the client software. The client software could perform encryption or decryption operations only for clients with the required permissions. In this case, however, it is theoretically possible for the client to circumvent the security of the system. This functionality may be extended with Key Control Vectors and tamper resistant hardware. It can also be extended by using different encryption for different clients.

### Cipher Choice

It is natural to wonder what ciphers are appropriate for use in this application. Although it depends largely on the final application requirements, a few things can be said:
Stream ciphers may not be a good choice because most applications will expect random access within the encrypted data.
Applications that do not need random access to files may use stream ciphers.
Some stream ciphers, such as the Salsa20 family of ciphers, allow efficient seeking to any position. These ciphers may work well even in applications that require random file access.
Without special consideration, it is not possible to separate encryption and decryption permissions. Symmetric ciphers use the same, or effectively the same key for encryption and decryption. Public-key ciphers, on the other hand, do not allow this since one key (the public key) can be derived from the other (the private key), thus encryption or decryption can be isolated, but not both. To achieve splitting of encryption and decryption permissions, two ciphers are needed, as explained in the next section.
Block ciphers, such as AES (the Advanced Encryption Standard), are generally good choices. When used in ECB mode, block ciphers allow random access are well understood and are already in widespread use. While ECB does have some security issues that must be considered, it may be good enough for many purposes. ECB+OFB, CBC and CFB may also be used as described in Schneider 10.4, though they do not offer random access.
Both block and stream ciphers may be used in “Counter Mode.” This offers high security, random access, a wide variety of cipher choices, and no issues with padding.

### Asymmetric Ciphers

The use of two asymmetric ciphers allows for separation of encryption and decryption permissions. We will show how this can be done.

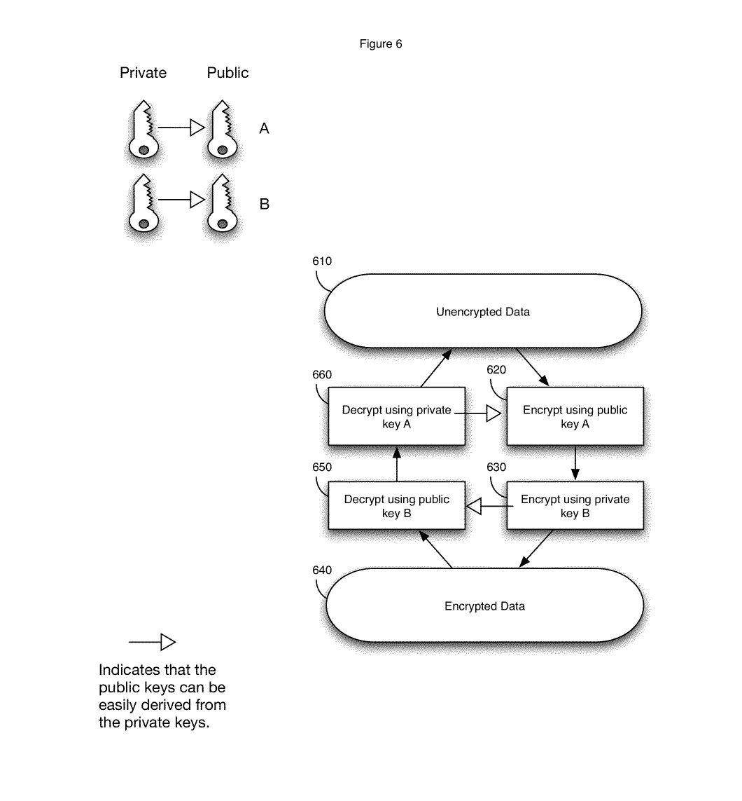

Asymmetric ciphers have two keys, called the public key and the private key. The public key can be easily derived from the private key, but not vice versa, as indicated by the open-arrow-head in FIG. 6. Given two keys, or, more properly, two key pairs, A and B, we will show how one user can be given the information required to encrypt and another the information to decrypt, but neither user will be able to perform the other's operation.

We wish to assign the first user encryption permission. We give this user the public key A, and private key B. The user starts with the unencrypted data, 610, encrypts the data first with the public key A 620, and then with private key B 630. The data is now encrypted 640. We note that this user can derive public key B from private key B, and can, therefore partially decrypt the data, but they cannot derive private key A and can therefore not completely decrypt any data.

To allow another user the ability to decrypt data without the ability to encrypt, we must give them access to the public key B and the private key A. This allows them to derive the public key A, but not the private key B. Therefore, they will be unable to encrypt data fully. To decrypt data 640, they first decrypt the data using public key B 650, and then using private key A 660. They have then obtained the unencrypted data 610.

### Collaboration and Permission

The invention described in this disclosure can be used in combination with a system for sharing information and to controlling permissions. When authentication is performed, access to the encrypted data and the encryption/decryption keys can be controlled, allowing the system designer to assign different levels of permissions and access to different data. Because the files may be stored centrally in at least one embodiment, different users can have access to some of the files allowing them to use the system to share files and collaborate.

One unusual feature of this system is that permission can be revoked, even after a file is downloaded. By removing a given user's permission to read a specific key, they may become unable to decrypt the information already on their computer. Although this system is not foolproof (a savvy user could store keys, if they anticipate loosing access to them), it is robust enough for many applications. Proper client software will be designed to treat the key as transient data that must be refreshed on a regular basis, and a properly designed server will require authentication for this refreshing to happen. Without the cipher key, the data remaining on the client computer will be impossible to decrypt. Therefore, the user will be unable to read it after their permission to access the key on the server has been revoked unless they deliberately broke the security of the system before their permission was revoked.

### Example Uses

The above methods and systems may be implemented in a variety of ways and in a variety of environments, including the following applications. For example, if encrypted data is too large to fit inside the client software's protected and/or short-lived memory space, but physical and software security are not certain, the present invention is likely to be useful. For example, audio and multimedia authoring applications use large amounts of data. This data is generally too much to be stored in RAM. It must therefore be stored in the general memory of the hard disk drive. However, there have been cases of computers used for such purposes being hacked into electronically, as well as cases of such computers being lost or stolen. In these cases, the data could have been protected if it had been encrypted and had the key resided on another system.

OS-based disk-encryption software already exists. However, the security could be increased if, instead of storing the key on the computer, or basing the key on a password, the key were stored on a separate server, and authentication, particularly authentication requiring user interaction, were required to access the key.

Anti-malware software (often called anti-virus software) could be developed which stores the key in its protected memory and allows client applications access encrypted files, depending on certain security rules. For example, the client could be checked against a list of known applications and even validated to see if it had been tampered with or modified.

There have been a number of highly publicized cases of data loss and data theft in recent years, some even involving banking information. It may not be possible to develop systems such as remote deletion or web-based solutions to solve these problems. For example, it may be necessary for banks to store large amounts of customer information on employee laptops. Storing this information on a server may make it difficult or impossible to work with the data in a manageable way. The system described here could be used to mitigate the risk presented to these companies by lost and stolen laptops, computers, cell phones, and other devices.

What we claim is:

1. A method for increasing security of data on in a computing system comprising:
maintaining a cipher key in a storage device on the server computer; and
delivering the cipher key from the server computer to the client computer, thereby allowing the client computer to decrypt or encrypt data as needed.

2. The method of claim 1, further comprising:
maintaining encrypted data in one of the storage device or a separate storage device on the server computer.

3. The method of claim 2, further comprising
delivering the encrypted data from the server computer to the client computer.

4. The method of claim 1, further comprising:
receiving encrypted data from the client, wherein the encrypted data is stored on a first storage device of the client.

5. The method of claim 1, further comprising:
authenticating the client at least one time via an authentication process.

6. The method of claim 5, where the authenticating requires user interaction.

7. The method of claim 6, further comprising:
using one of a block cipher and a stream cipher to encrypt the data.

8. The method of claim 7, wherein the block cipher is an AES.

9. The method of claim 7, wherein the stream cipher allows a seeking to any location.

10. The method of claim 7, wherein where the stream cipher is in the Salsa20 family.

11. The method of claim 1, further comprising:
allowing the client computer to encrypt data using the cipher key.

12. The method of claim 1, further comprising:
the use of two asymmetric ciphers for encrypting and decrypting data.

13. The method of claim 1, further comprising:
maintaining one or more cipher keys on a second storage device of the client computer; and
using the cipher keys stored on the second storage device of the client computer to decrypt or encrypt data as needed.

14. The method of claim 13, further comprising:
receiving, by a different computing device, encrypted data from the client.

15. The method of claim 1, further comprising:
authenticating at least one client computer for at least one of collaboration, assignment and enforcing of access permissions.

16. The method of claim 1, where encrypting and decrypting data is performed by a library, plug-in, service, or external module of the client computer.

17. The method of claim 1 further comprising:
checking for the presence of a whitelist, a malware or a tampering before providing the cipher key.
